(19) United States
(12) Patent Application Publication
(10) Pub. No.: US 2005/0095399 A1
(43) Pub. Date: May 5, 2005

(54) Ultraviolet absorption and radiation shielding for raw materials and products

(75) Inventors: Dennis Loyd, West Chester, OH (US); Larry Lough, Springdale, OH (US)

Correspondence Address: Schwegman, Lundberg, Woessner & Kluth, P.A., P.O. Box 2938, Minneapolis, MN, 55402, US

(73) Assignee: Tri E Holding, LLC

(21) Appl. No.: 10/701,875

(22) Filed: Nov. 5, 2003

(51) Int. Cl. B05D 1/12; B32B 5/16

(52) U.S. Cl. 428/149; 106/286.1; 427/180

(57) ABSTRACT

Techniques are provided for using glass waste as an additive to raw materials for unfinished products or as a coating for finished products. Glass waste is crushed into glass particles forming a powder. The powder includes metal that does not leach out of the glass particles. The powder can be mixed with raw materials in the process of making products. Alternatively, the powder can be mixed with other liquids and directly applied as a coating to finished products. The metal creates properties in the products that result in Ultraviolet (UV) absorption, radiation shielding, and sound blockage.

### FIELD OF THE INVENTION

The present invention is related to Ultraviolet (UV) absorbers and radiation shields, and more specifically to using glass waste to mix with materials of an unfinished product or to apply glass waste as a coating to a finished product for purposes of increasing UV absorption and radiation shielding properties in the products.

### BACKGROUND OF THE INVENTION

Every year an abundance of glass waste is produced in the world economy. Some of this glass waste includes high concentrations of lead that if not properly treated will leach into the environment and create unsafe or hazardous environmental conditions. Other glass waste is associated with consumer packaging and containers which are safe for disposal or reuse in other consumer packaging or containers.

Presently, much of what is considered safe glass waste is not recycled and is often disposed of in landfills. Moreover, what glass waste that is recycled is recycled for purposes of producing another glass product. Glass waste that is not considered safe for disposal undergoes a variety of processes intended to make the hazardous glass waste safe for disposal. Hazardous glass waste (e.g., CRT glass) is generally recycled back into other hazardous glass waste products (e.g., other CRT monitors) or disposed of in a landfill.

Additionally, many consumer products or industry products currently use additives which are designed to prevent Ultraviolet (UV) absorption. The favored additives are Zinc Oxides, Iron Oxides, Titanium Dioxides, and other organic UV absorbers, such as Benzotriazoles and others.

Excessive UV exposure can alter the color and can cause other damage or degradation to the physical properties and performance characteristics of consumer or industry products. Accordingly, the market need for UV additives is substantial. However, present UV additives are expensive and add substantial costs to the products that they are used within.

Accordingly, there is a need for less-expensive additives for use with raw building materials, unfinished products, and finished products. These additives should be inexpensive vis-a-vis conventional additives and exhibit UV absorption properties that are comparable to convention additives.

### SUMMARY OF THE INVENTION

Briefly and in general terms, glass waste is crushed into a powder form; the powder may include contaminants, such as lead, and the powder will include other non-hazardous metals. The powder can be mixed with raw materials of unfinished products or can be combined with other liquids and applied as a coating to finished products. The lead or other metal acts as a Uv absorber, radiation shield, and sound blocker.

More specifically, and in one embodiment, a method of adding Ultraviolet (UV) absorber and radiation shielding properties to products are presented. Glass waste is crushed into glass particles. The glass particles are applied to a product. The metal included within the glass particles creates a UV absorber or radiation shield for the product.

In still another embodiment, an Ultraviolet (UV) absorbing and radiation shielding additive is described. The additive is a powder form of crushed glass waste. The powder is used as an additive to raw materials for unfinished products or mixed with other liquids and applied to finished products. The crushed glass waste includes metal that acts as an UV absorber or radiation shield for the unfinished products and the finished products.

In yet another embodiment, an UV absorbing and radiation shielding system is taught. The UV absorbing and radiation shielding system includes a glass waste treatment system and a packaging system. The glass waste treatment system is used to prevent metal from leaching out of glass particles which are produced from the glass waste. The packaging system is used for packaging the glass particles in a liquid or solid form which is used to mix with materials for unfinished products or used as a coating to finished products.

Still other aspects of the present invention will become apparent to those of ordinary skill in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 is a flowchart of a method for creating UV absorber and radiation shielding properties in products according to one embodiment of the present invention.

FIG. 2 is a diagram of an UV absorbing and radiation shielding additive according to one embodiment of the present invention.

FIG. 3 is a diagram of an UV absorbing and radiation shielding system according to one embodiment of the present invention.

### DETAILED DESCRIPTION OF THE INVENTION

In the following description and the drawings illustrate specific embodiments of the invention sufficiently to enable those of ordinary skill in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

In various embodiments of the present invention, the phrase “glass waste” is used. Glass waste can include hazardous glass waste such as Cathode Ray Tube (CRT) glass from computer or television monitors or glass waste can include non-hazardous glass waste that may be recycled by a consumer, such as glass containers used for packaging consumer goods, such as beverages, food, cleaning supplies, and the like.

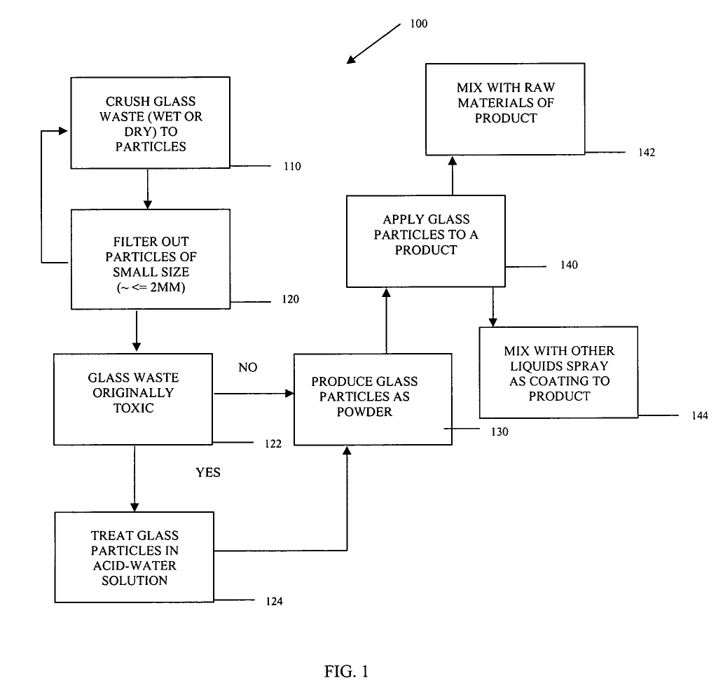

FIG. 1 illustrates a flowchart of one method 100 for creating UV absorbent and radiation shielding properties in products. The method 100 is achieved through the use of waste disposal equipment or devices. Moreover, the method 100 is integrated with and processed in connection with devices and methods that are used to produce consumer products, consumer packaging, or building materials. Furthermore, the method 100 can be used as a post process after finished consumer products have been produced for purposes of adding coatings to the finished products, as described herein and below.

Initially, glass waste is acquired. The glass waste can be hazardous such as waste attributed to Cathode Ray Tubes (CRT) used in monitors. Moreover, the glass waste can be in a solid form or in a liquid form, such as glass slurry. Alternatively, the glass waste can be non hazardous such as glass containers used to hold beverages, cleaning products, household products, or food. The glass waste is initially, at 110, crushed into glass particles having diameter sizes of less than or equal to 2 millimeters.

At these small glass particles sizes the lead and other modifying metals (herein after Cerium Oxide, Manganese Oxide, Iron Oxide, Cobalt Oxide, Copper Oxide, Vanadium Oxide, Molybdenum Oxide, Barium Oxide, and other salts which may or may not be present in the composition of the glass waste) contained within the composition of the glass will not leach out of the glass particles. This is so, because the diameter of the individual glass particles is of a size that the mass stress equation requires an external force that typically cannot be found in nature in order to facture the glass particles and thereby permit the lead or other modifying metals to leach from the glass particles. Thus, the small glass particles, at sizes of 2 millimeters or less in diameter, are safe for disposal and for reuse. Thus, by changing the form of the glass waste certain beneficial physical properties are achieved that can make the glass particles associated with a changed form of the original glass waste safe for human handling and consumption.

At 120, any glass particles that have diameter sizes of greater than approximately 2 millimeters are crushed again back at 110. At 122, a check is made to determine if the filtered glass particles were originally associated with hazardous glass waste. Accordingly, if the glass particles were originally associated with hazardous glass waste, then, at 124, the glass particles are circulated in an acid-water solution for a configurable period of time. During this acid-circulation bath, any surface lead or other heavy metal is extracted from the glass particles. Next, the glass particles are rinsed. At this point, if the glass particles were originally associated with hazardous glass waste, the glass particles are now safe for disposal or reuse in other products.

Optionally, the filtered and crushed glass particles can be rinsed and/or dried after they have been treated, as necessary, and are in the required size of less than or equal to 2 millimeters in diameter size.

At 130, the filtered and optionally treated glass particles are produced as a solid represented in consistency as a powder. The powder is essentially glass and contains lead and other modifying metals as part of the composition of the glass. But, the lead or other modifying metals will not leach from the glass, which means the powder is safe to be reused and disposed of if desired. Moreover, lead or other modifying metals included in the composition of the powder includes properties that can be beneficial to products. Most notably, lead and the modifying metals included within the powder are good UV absorbers, radiation shields, and sound blockers.

Conventionally, products are augmented with UV absorbers such as Zinc Oxide, Titanium Dioxide, and other additives. These conventionally preferred UV absorbers are expensive. In fact, comparisons between lead vis-à-vis Zinc Oxide and Titanium Dioxide show that lead is a comparable UV absorber to these conventional absorbers. But, lead and the other modifying metals in the composition of the glass powder are more transparent than the conventional additives. Thus, the comparable level of UV absorbency is obtained with the glass powder of the present invention at a much lower production cost with increased transparency when compared to conventional absorbers.

Therefore, the glass particles represented by the powder provides a set of unique possibilities for the economy. That is, glass waste has been conventionally disposed of or used in recycling for the primary purpose of creating recycled glass products. Conventionally, in the recycling situations, the original glass waste is restricted to non hazardous glass waste. With the teachings of this invention, what has been conventionally disregarded as waste or minimally used for recycling purposes can now be used in replace of conventional UV absorbers as additives to products. This is substantially less expensive than using convention UV absorbers and provides improved product properties, such as improved transparency.

Thus, at 140, the glass particles (powder form) are applied to a product. Application can occur in two different situations: (1) mixing with raw materials used in the fabrication process of unfinished products; and (2) coating finished products in a post fabrication process with the glass particles.

In the first situation, at 142, the glass particles can be mixed with raw materials of an unfinished product, so that the glass particles become part of the composition of a finished product produced from the unfinished product.

For example, an outer plastic shell of cell phone, a plastic bottle used for holding household goods, beverages, or food, an adhesive, a paint, a sealant, and the like can include in their production processes a step for the mixing the glass particles into their native raw materials. As a result, the finished products from such a process will include properties associated with lead or other modifying metals that can substitute and enhance what has been conventionally done with Zinc Oxide, Titanium Dioxide, and other additives. That is, these finished products will exhibit characteristics that include UV absorption, radiation shielding, and sound blockage.

In a particular example, exposure to radiation from cell phone usage is a growing concern in the industry, but cell phone outer shells produced with the glass particles of the present invention will block this exposure to radiation.

In another example, consider conventional X-ray rooms, where lead aprons and lead lined walls are used to protect patients and X-ray technicians from radioactive exposure. Now such a lead shields can be cost effectively manufactured within the native composition of clothing and other materials, to improve X-ray shielding for individuals that are at high risk of exposure. For example, paper gowns can be coated with or printed on with the glass particles of the present invention. This gives the clothing added X-ray protection.

As another example, the beverage industry is continually plagued with flat or unfavorable taste associated with UW exposure to their products. To address this problem, the beverage industry introduces UV absorbers into the raw materials of the plastics. However, these conventional absorbers do not perform better than lead and often add considerably to the price of the packaging (e.g., bottle containers). With the teachings of this invention, the glass particles are mixed with the plastics resulting in finished beverage containers that are comparable UV absorbers, since they include lead and other modifying metals and these UV absorbers are cheaper to manufacture into the containers. Moreover, the containers that use the glass particles of the present invention are more transparent than what can be conventionally achieved with conventional additives. Thus, containers can now be made more transparent in order to show the product included within (e.g., orange juice) without giving up any UV absorbency properties.

As another example, consider consumer cosmetics that are often produced with Zinc Oxide to block the harmful radiation effects associated with UV exposure. Zinc Oxide does not block UV any better than lead glass or other modifying metals present in the glass and is considerably more expensive to use than is lead or other modifying metals, which are obtained from glass waste. Once more, since the glass particles include metal in a form that will not leach; the glass particles are safe for human exposure. Additionally the lead and other modifying metals found in the glass particles are more transparent and affect the color of the native cosmetics less than what conventional Zinc Oxides do.

The variation in products that can benefit from the UV absorbency and radiation shielding properties of the present invention is nearly limitless. For example, the glass particles can be added to building materials to reduce the harmful effects associated with UV and radiation exposure. The glass particles can be added to inks or paints and because of lead's UV absorbing properties, there is improved light fastness properties permitting more color variations in the inks or paints that have heretofore not been possible. In addition, the glass particles can be added to stains, siding, or other materials to create better and improved sound blockage. Moreover, compounds such as adhesives typically break down after prolonged exposure to UV, but adhesives that mix the glass particles of the present invention will experience a longer life span than what has been conventionally achievable with conventional UV absorbers.

Accordingly, the glass particles can be introduced into the native raw materials for unfinished products during the normal product fabrication process in order to produce finished products that have improved characteristics. These improved characteristics include better UV absorption, radiation shielding, and sound blockage.

In other embodiments, finished products can be coated with the glass particles represented in a powder form at 144. In these embodiments, the glass particles are mixed with other liquids, such as paints, stains, resins, solvents, water, and the like and sprayed onto the finished products. Alternatively, the finished products can be dipped into a bath of the glass particles and other liquids. In some instances, the finished products can have the glass particles printed on to them, such as with paper products. In other embodiments, the glass particles can be brushed with the glass particles. The lead and other modifying metals found in the composition of the glass particles are nearly entirely transparent such that no color variation will be detectable in the finished product. In fact, lead glass is more transparent than conventional UV absorbers (Zinc Oxide, Titanium Dioxide, and others). Moreover, the finished product will experience the same beneficial properties as what is recognized with lead and the other modifying metals, namely better UV absorption, radiation shielding, and sound blockage.

Conventionally, the industry has used expensive compounds such as Zinc Oxide, Titanium Dioxide, and the like to add to products or to coat onto products. Moreover, conventionally, hazardous glass waste has been strictly disregarded and disposed of and non-hazardous glass waste has only been used for very limited recycling and then for only glass-related recycled products. With the teachings of this invention, that glass waste is crushed into very small particles that have unique properties that prevent lead and the other modifying metals found within the particles from leaching out of the particles. The particles form a powder that can be used as a performance modifying additive to raw materials for unfinished products or used in combination with other liquids to coat finished products. The results are products that have improved UV absorbing properties, better radiation shielding, and better sound blockage. These enhanced products are also less expensive to produce, because the lead and other modifying metals are readily available from existing glass waste, which has heretofore been primarily disregarded and disposed of. Furthermore, the resulting products can be made to be more transparent, since the lead glass associated with the glass particles are more transparent than conventional additives used with consumer or industry products.

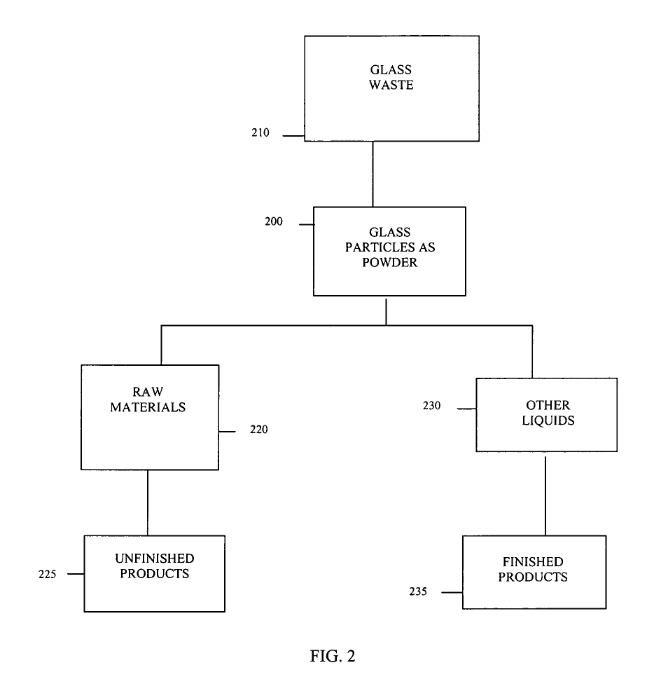

FIG. 2 is a diagram of one UV absorbing and radiation shielding additive 200. The additive 200 is a solid powder of glass particles derived from glass waste 210. The glass particles have diameter sizes of less than or equal to 2 millimeters in diameter sizes. At this small size, the lead other modifying metals (Cerium Oxide, Manganese Oxide, Iron Oxide, Cobalt Oxide, Copper Oxide, Vanadium Oxide, Molybdenum Oxide, Barium Oxide, and other salts present in the composition of the glass) which still remains in the composition of the glass are not capable of leaching from the glass particles. This is so because, at these small sizes the mass to stress equation denotes a force required for fracture to any single glass particle as being so excessive that it cannot practically be achieved in nature. This unique property of the small glass particles makes the glass particles safe for human exposure, consumption, and disposal.

In some embodiments, the original glass waste 210 is associated with hazardous glass waste (e.g., CRT monitor glass and the like). In these embodiments, after the glass particles are produced from the glass waste they are treated in a chemical process where they are exposed to an acid-water bath to extract any remaining surface heavy metals from the glass particles. Next, the treated glass particles are rinsed. At this point, even glass waste 210 that was originally hazardous is now non hazardous and available for use with the teachings of the present invention.

The glass particles take on a solid form as a fine-grained powder 200 at their small sizes. The powder 200 can be added to the fabrication process of unfinished products 225, where the powder 200 is mixed with raw materials of the unfinished products 225. The finished products that include the powder 200 will exhibit characteristics associated with lead and the other modifying metals found in the composition of the glass particles, but the harmful effects of the metals are removed because the metals are not capable of leaching from the product. Thus, the products will be good UV absorbers, radiation shields, and sound blockers. Moreover, the lead and other modifying metals found in the composition of the glass particles are nearly transparent, which means there is little to no detectable affect on the original color attributes associated with the products that integrate the glass particles.

The powder 200 can also be used to mix with other liquids 230 or coatings and applied directly to finished products 235. Application can be made by spraying the finished products 235 with the powder 200 in a liquid form or by dipping the finished products 235 in a tank having the powder 200 in a liquid form. In some embodiments, application can be made by printing the liquid form onto the product. The finished products 235 will include the beneficial properties associated with lead and the other modifying metals found in the composition of the powder 200, but without the harmful effects normally associated with the metals, since the metals are not capable of practically leaching from the finished products 235.

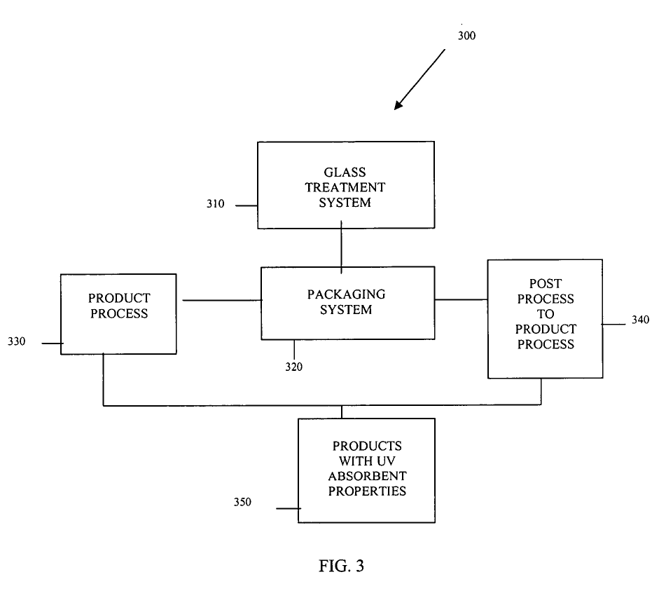

FIG. 3 is a diagram of one UV absorbing and radiation shielding system 300. The system 300 includes a glass treatment system 310 and a packaging system 320. The glass treatment system 310 is designed to treat hazardous glass waste and transform glass waste (whether hazardous or not) into glass particles having diameter sizes of 2 millimeters or less. At these small diameter sizes, metals are not practically capable of leaching from the composition of the glass particles. Thus, the glass particles are safe for human exposure, consumption, and disposal.

The packaging system 320 packages the glass particles in liquid or solid forms. The solid form is a powder substance and the liquid form is the powder substance mixed with other liquids (e.g., sealants, paints, adhesives, resins, solvents, water, etc.). The solid form is primarily used as an additive to an existing product's fabrication process 330. This performance-modifying additive is mixed with the raw materials of a product during its fabrication process 330. The result is a product 350 having embedded characteristics associated with lead and other modifying metals found in the composition of the glass particles, but without the normal harmful risks associated with metals that can leach from a product. These characteristics include improved UV absorption, radiation shielding, and sound blockage.

The packaging system 320 can also produce the powder in liquid forms, which can be used in a post process to a product's fabrication process 340. The liquid forms are used to coat a finished product with the liquid. Coating can occur by brushing, spraying, printing, or dipping a finished product with the liquid. The result is a product 350 having the beneficial properties associated with lead and the other modifying metals found in the composition of the glass particles, but without the harmful exposure risks normally associated with metals, since the metals are not capable of practically leaching from the glass particles of the liquid.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to one of ordinary skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method of adding Ultraviolet (UV) absorbent and radiation shielding properties to products, comprising:
crushing glass waste into glass particles; and
applying the glass particles to a product, wherein metal included within the glass particles creates an UV absorber or radiation shield for the product.

2. The method of claim 1 wherein the crushing further includes crushing the glass waste into the glass particles, wherein the glass particles have diameter sizes less than or equal to 2 millimeters.

3. The method of claim 2 further comprising circulating the glass waste in an acid-water solution and rinsing the glass particles thereafter before performing the applying.

4. The method of claim 1 wherein the crushing further includes producing the glass particles as a powder.

5. The method of claim 1 wherein the applying further includes mixing the glass particles with raw materials of the product, wherein the raw materials are associated with building materials.

6. The method of claim 1 wherein the applying further includes mixing the glass particles with raw materials of the product, wherein the raw materials are used to produce a consumer product.

7. The method of claim 1 wherein the applying further includes at least one of spraying, printing, and dipping the product into the liquid form of the glass particles, wherein the product is a finished product.

8. An Ultraviolet (UV) absorbing and radiation shielding additive, comprising:
a powder form of crushed glass waste that is used as an additive to raw materials for unfinished products or mixed with other liquids and applied to finished products, wherein the crushed glass waste includes metal that acts as an UV absorber or radiation shield for the unfinished products and the finished products.

9. The UV absorbing and radiation shielding additive of claim 8 wherein the metal also serves as a sound barrier for the unfinished products and the finished products.

10. The UV absorbing and radiation shielding additive of claim 8 wherein the metal also serves as the radiation shield for the unfinished products and the finished products.

11. The UV absorbing and radiation shielding additive of claim 8 wherein the metal increases the color variations obtainable in the unfinished products and the finished products.

12. The UV absorbing and radiation shielding additive of claim 8 wherein the metal increases a lifespan of adhesive properties in the unfinished products and the finished products.

13. The UV absorbing and radiation shielding additive of claim 8 wherein the glass waste is treated preventing the metal from leaching out of the powder.

14. The UV absorbing and radiation shielding additive of claim 8 wherein the glass waste is obtained from existing safe consumer glass products requiring no additional treatment.

15. An UV absorbing and radiation shielding system, comprising:
a glass waste treatment system to prevent metal from leaching out of glass particles produced from the glass waste; and
a packaging system to package the glass particles in a liquid or solid form which is used to mix with materials for unfinished products or used as a coating for finished products.

16. The UV absorbing and radiation shielding system of claim 15 wherein the glass waste treatment system includes a grinder that grinds the glass waste into the glass particles, wherein the glass particles have diameter sizes of less than or equal to 2 millimeters.

17. The UV absorbing and radiation shielding system of claim 16 wherein the glass waste treatment system includes a circulating tank for circulating the glass particles in an acid and water solution.

18. The UV absorbing and radiation system of claim 15 wherein the liquid form is an aerosol used for spraying the glass particles onto the finished products.

19. The UV absorbing and radiation shielding system of claim 15 wherein the solid form is a powder that is mixed with the raw materials of the unfinished products.

20. The UV absorbing and radiation shielding system of claim 15 wherein the unfinished and finished products when combined with the glass particles produce properties in created products that exhibit at least one of absorbing UV light, blocking sound waves, and shielding radiation.
